(19) United States
(12) Patent Application Publication
(10) Pub. No.: US 2025/0299890 A1
(43) Pub. Date: Sep. 25, 2025

(54) CAPACITOR ELEMENT

(71) Applicant: Murata Manufacturing Co., Ltd., Nagaokakyo-shi (JP)

(72) Inventors: Katsuhiko TOKUDA, Nagaokakyo-shi (JP); Takeshi Furukawa, Nagaokakyo-shi (JP)

(21) Appl. No.: 19/227,767

(22) Filed: Jun. 4, 2025

Related U.S. Application Data
(63) Continuation of application No. PCT/JP2024/027016, filed on Jul. 29, 2024.

(30) Foreign Application Priority Data
Aug. 7, 2023 (JP) 2023-128315

(51) Int. Cl. H01G 9/048; H01G 9/042; H01G 9/10; H01G 9/15

(52) U.S. Cl. CPC H01G 9/048; H01G 9/042; H01G 9/10; H01G 9/15

(57) ABSTRACT

A capacitor element that includes: a positive electrode plate including a porous layer on at least one main surface thereof; a dielectric layer on a surface of the porous layer; a negative electrode layer on a surface of the dielectric layer; and an insulating layer on the surface of the dielectric layer and arranged so as to partially overlap the negative electrode layer, wherein d1≥0.2×d2, where d1 is a layer thickness of an overlapping portion of the negative electrode layer and the insulating layer at an end of the insulating layer overlapping the negative electrode layer, and d2 is a layer thickness of the insulating layer.

### CROSS REFERENCE TO RELATED APPLICATIONS

The present application is a continuation of International application No. PCT/JP2024/027016, filed Jul. 29, 2024, which claims priority to Japanese Patent Application No. 2023-128315, filed Aug. 7, 2023, the entire contents of each of which are incorporated herein by reference.

### TECHNICAL FIELD

The present disclosure relates to a capacitor element.

### BACKGROUND ART

Patent Document 1 describes a capacitor array including a plurality of solid electrolytic capacitor elements into which one solid electrolytic capacitor sheet is partitioned, a sheet-shaped first sealing layer, and a sheet-shaped second sealing layer. The solid electrolytic capacitor sheet includes a positive electrode plate made of a valve action metal, a porous layer provided on at least one main surface of the positive electrode plate, a dielectric layer provided on a surface of the porous layer, and a negative electrode layer including a solid electrolyte layer provided on a surface of the dielectric layer, and has a first main surface and a second main surface that face each other in a thickness direction. The first main surface side of each of the plurality of solid electrolytic capacitor elements is disposed on the first sealing layer. The second sealing layer is disposed so as to cover the plurality of solid electrolytic capacitor elements on the first sealing layer from the second main surface side. The solid electrolytic capacitor elements are partitioned by a slit-shaped sheet removing portion.

Patent Document 1: Japanese Unexamined Patent Application Publication No. 2020-167361

### SUMMARY OF THE DISCLOSURE

For example, in FIG. 27 of Patent Document 1, if there is a difference in layer thickness between a conductive layer portion (negative electrode layer 24) and an insulating layer portion (stress relaxation layer 13, insulating layer 30) and a transition portion between these, a pressure that is applied to each layer when a sealing layer is formed by affixing a resin sheet becomes nonuniform, and there is a possibility that the closeness of contact at the interface between a thin layer, that is, the transition portion, and the sealing layer may decrease. As a result, there is a possibility that peeling-off called delamination, such as peeling-off of the sealing layer, may occur.

The present disclosure has been made in order to solve the above problem, and an object thereof is to provide a capacitor element that can improve the closeness of contact at the interface between a sealing layer and a base thereof and that can suppress delamination.

A capacitor element according to the present disclosure includes: a positive electrode plate including a porous layer on at least one main surface thereof; a dielectric layer on a surface of the porous layer; a negative electrode layer on a surface of the dielectric layer; and an insulating layer on the surface of the dielectric layer and arranged so as to partially overlap the negative electrode layer, wherein d1>0.2×d2, where d1 is a layer thickness of an overlapping portion of the negative electrode layer and the insulating layer at an end of the insulating layer overlapping the negative electrode layer, and d2 is a layer thickness of the insulating layer.

With the present disclosure, it is possible to provide a capacitor element that can improve the closeness of contact at the interface between a sealing layer and a base thereof and that can suppress delamination.

### BRIEF DESCRIPTION OF THE DRAWINGS

FIG. 1 a schematic sectional view illustrating an example of a capacitor element according to a first embodiment of the present disclosure.

FIG. 2 is a schematic enlarged view illustrating an example of a region of the capacitor element surrounded by a broken line in FIG. 1.

FIG. 3 is a schematic enlarged view illustrating another example of the region of the capacitor element surrounded by the broken line in FIG. 1.

FIG. 4 is a schematic plan view illustrating an example of a capacitor array according to a second embodiment of the present disclosure.

FIG. 5 is a schematic sectional view illustrating an example of a cross section of the capacitor array taken along line A-A in FIG. 4.

FIG. 6 is a schematic sectional view illustrating an example of a cross section of the capacitor array taken along line B-B in FIG. 4.

FIG. 7 is a schematic plan view illustrating an example of a capacitor array according to a third embodiment of the present disclosure.

FIG. 8 is a schematic sectional view illustrating an example of a cross section of the capacitor array taken along line A-A in FIG. 7.

FIG. 9 is a schematic sectional view illustrating an example of a cross section of the capacitor array taken along line B-B in FIG. 7.

### DESCRIPTION OF THE PREFERRED EMBODIMENTS

Hereafter, a capacitor element according to the present disclosure will be described. Note that the present disclosure is not limited to configurations described below, and may be modified as appropriate within the gist of the present disclosure. Various combinations of a plurality of preferred configurations described below are also included in the present disclosure.

Embodiments described below are examples, and, needless to say, it is possible to partially replace or combine configurations described in different embodiments. the second and third embodiments, descriptions of matters common to those of the first embodiment will be omitted, and differences from the first embodiment will be mainly described. In particular, similar advantageous effects due to similar configurations will not be described for each embodiment.

In the following description, if it is not necessary to discriminate between embodiments, the term “a capacitor element according to the present disclosure” will be used.

In the present description, terms expressing the relationships between elements (such as “perpendicular”, “parallel”, and “orthogonal”) and terms expressing the shapes of elements not only have strict meanings but also have meanings in a substantially equivalent range with, for example, a difference of about several percents.

The figures used in the following description are schematic figures, and dimensions, aspect ratios, scales, and the like may differ from those of an actual product.

### First Embodiment

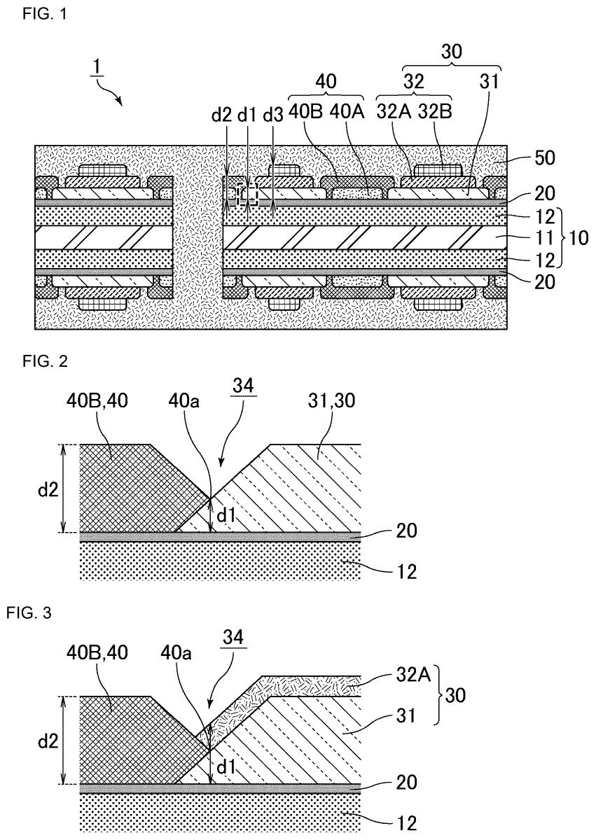

FIG. 1 is a schematic sectional view illustrating an example of a capacitor element according to a first embodiment of the present disclosure.

A capacitor element 1 illustrated in FIG. 1 includes a positive electrode plate 10, a dielectric layer 20, a negative electrode layer 30, and an insulating layer 40.

The positive electrode plate 10 includes a core portion 11 and a porous layer 12.

In the present description, “plate” includes “sheet”, “foil”, “film”, and the like, and these are not discriminated by thickness.

The core portion 11 is made of a metal, and is preferably made of a valve action metal among others. When the core portion 11 is made of a valve action metal, the positive electrode plate 10 is also called a valve action metal base.

Examples of the valve action metal include: elemental metals such as aluminum, tantalum, niobium, titanium, and zirconium; and alloys each containing at least one of these elemental metals. Among these, aluminum or an aluminum alloy is preferable.

The porous layer 12 is provided on at least one main surface of the core portion 11. That is, the porous layer 12 may be provided on one main surface of the core portion 11, or may be provided on each of two main surfaces of the core portion 11 as illustrated in FIG. 1. In this way, the positive electrode plate 10 includes the porous layer 12 on at least one main surface thereof. Thus, the surface area of the positive electrode plate 10 is increased, and it becomes easier to increase the capacitance of the capacitor element 1.

The porous layer 12 is preferably an etching layer formed by etching a surface of the positive electrode plate 10.

The positive electrode plate 10 is preferably a flat plate-shaped, and more preferably foil-shaped. In this way, in the present description, “plate-shaped” includes “foil-shaped”. Moreover, in the present description, “plate-shaped” includes “sheet-shaped”, “film-shaped”, and the like.

The dielectric layer 20 is provided on a surface of the porous layer 12. Although illustrated in a simplified form in the figures, to be more specific, the dielectric layer 20 is provided along the surfaces (contours) of pores that are present in the porous layer 12.

The dielectric layer 20 is preferably made of an oxide film of the aforementioned valve action metal. For example, when the positive electrode plate 10 is an aluminum foil, an oxide film to become the dielectric layer 20 is formed by anodizing (in other words, chemically converting) the positive electrode plate 10 in an aqueous solution including ammonium adipate or the like. Since the dielectric layer 20 is formed along the surface of the porous layer 12, pores (recesses) are formed in the dielectric layer 20.

The negative electrode layer 30 is provided on a surface of the dielectric layer 20. To be more specific, the negative electrode layer 30 is provided on the surface of the dielectric layer 20 in a region surrounded by the insulating layer 40.

In FIG. 1, the negative electrode layer 30 includes a solid electrolyte layer 31 provided on the surface of the dielectric layer 20 and a conductor layer 32 provided on a surface of the solid electrolyte layer 31. When the negative electrode layer 30 includes the solid electrolyte layer 31, the capacitor element is a solid electrolytic capacitor.

Examples of the materials of the solid electrolyte layer 31 include electroconductive polymers such as polypyrrole, polythiophene, and polyaniline. Among these, polythiophene is preferable, and poly(3,4-ethylenedioxythiophene) (PEDOT) is particularly preferable. The electroconductive polymer may include a dopant such as polystyrene sulfonate (PSS).

The solid electrolyte layer 31 is formed, for example, in a predetermined region including the inside of the pores of the dielectric layer 20 by using a method such as: a method of applying a dispersion liquid of an electroconductive polymer such as poly(3,4-ethylenedioxythiophene) to the surface of the dielectric layer 20; or a method of forming, on the surface of the dielectric layer 20, a polymer film such as poly(3,4-ethylenedioxythiophene) film by using a treatment liquid including a polymerizable monomer such as 3,4-ethylenedioxythiophene.

The conductor layer 32 preferably includes a metal layer containing a metal filler.

The metal filler is preferably at least one selected from the group consisting of a copper filler, a silver filler, and a nickel filler.

The metal layer may be, for example, a metal plating film, a metal foil, or the like. In this case, the metal layer is preferably made of at least one metal selected from the groups consisting of copper, silver, nickel, and an alloy including at least one of these metals as the main component.

In the present description, “main component” means a component having the highest weight percent.

The conductor layer 32 preferably includes an electroconductive resin layer in addition to the metal layer.

Examples of the electroconductive resin layer include an electroconductive adhesive layer that contains at least one electroconductive filler selected from the group consisting of a copper filler, a silver filler, a nickel filler, and a carbon filler.

The conductor layer 32 may include only a metal layer, may include only an electroconductive resin layer, or may include both of a metal layer and an electroconductive resin layer.

In the example illustrated in FIG. 1, the conductor layer 32 includes a first conductor layer 32A provided on the surface of the solid electrolyte layer 31 and a second conductor layer 32B provided on a surface of the first conductor layer 32A. In this way, the conductor layer 32 preferably includes conductor layers of a plurality of types.

Regarding a solid electrolytic capacitor, a problem of a leakage current tends to arise due to a small thickness of a dielectric layer. However, since the conductor layer 32 includes conductor layers of a plurality of types such as the first conductor layer 32A and the second conductor layer 32B, a plurality of bulk resistances and interface resistances are present in the negative electrode layer 30, and thus a leakage current can be easily suppressed.

The first conductor layer 32A is preferably an electroconductive resin layer containing an electroconductive filler.

The second conductor layer 32B is preferably a metal layer containing a metal filler.

The conductor layer 32 may include, for example, a carbon layer as the first conductor layer 32A and a copper layer as the second conductor layer 32B.

The carbon layer is formed, for example, in a predetermine region by applying a carbon paste containing a carbon filler to the surface of the solid electrolyte layer 31 by sponge transfer, screen printing, dispenser application, inkjet printing, or the like.

The copper layer is formed, for example, in a predetermine region by applying a copper paste containing a copper filler to a surface of the carbon layer by sponge transfer, screen printing, splay application, dispenser application, inkjet printing, or the like

The planar shape of the outer peripheral edge of each layer of the negative electrode layer 30 when seen from the thickness direction is, for example, a quadrangular shape (square shape). However, the planar shape of the outer peripheral edge of each layer of the negative electrode layer 30 may be another shape, such as a rectangular shape, which is a quadrangular shape other than a square shape, a polygonal shape other than a quadrangular shape, a circular shape, or an elliptical shape.

In the present description, “thickness direction” means the thickness direction of a capacitor element, which is, for example, the up-down direction in FIG. 1.

In the capacitor element 1, the positive electrode plate 10, the dielectric layer 20, and the negative electrode layer 30 constitute a capacitor portion.

The insulating layer 40 is made of an insulating material.

Examples of the insulating material of the insulating layer 40 include polyphenylsulfone (PPS), polyethersulfone (PES), a cyanate ester resin, a fluororesin (tetrafluoroethylene, tetrafluoroethylene/perfluoroalkyl vinyl ether copolymer, or the like), a composition of a soluble polyimide siloxane and an epoxy resin, a polyimide resin, a polyamide-imide resin, and a derivative or a precursor of these.

The insulating layer 40 is provided on the surface of the dielectric layer 20. The insulating layer 40 is provided so as to partially overlap the negative electrode layer 30. The insulating layer 40 is provided on the periphery of the negative electrode layer 30.

In FIG. 1, the insulating layer 40 includes a first insulating layer 40A provided on the surface of the dielectric layer 20 in a region surrounding the solid electrolyte layer 31, and a second insulating layer 40B provided on a surface of the first insulating layer 40A. The second insulating layer 40B is provided so as to partially overlap the solid electrolyte layer 31.

FIG. 2 is a schematic enlarged view illustrating an example of a region of the capacitor element surrounded by a broken line in FIG. 1.

Referring to FIGS. 1 and 2, the capacitor element 1 satisfies d1≥0.2×d2, where d1 is the layer thickness of an overlapping portion 34 of the negative electrode layer 30 and the insulating layer 40 at an end 40a of the insulating layer 40 overlapping the negative electrode layer 30, and d2 is the layer thickness of the insulating layer 40. Thus, it is possible to reduce the difference in layer thickness between the negative electrode layer 30 and the insulating layer 40 and a transition portion (the overlapping portion 34) between these. Therefore, it is possible to equalize a pressure that is applied to each layer when a sealing layer 50 is being formed by, for example, affixing a resin sheet, and to improve the closeness of contact at the interface between the sealing layer 50 after the sealing layer 50 has been formed and each layer that is a base thereof. As a result, delamination, such as peeling-off of the sealing layer 50, can be suppressed.

As illustrated in FIG. 2, the overlapping portion 34 at the end 40a of the insulating layer 40 is preferably composed of the insulating layer 40 and at least one of the solid electrolyte layer 31 and the carbon layer as the first conductor layer 32A. In this way, by causing the insulating layer 40 and at least one of the solid electrolyte layer 31 and the carbon layer as the first conductor layer 32A to overlap at the thinnest part of the transition portion between the negative electrode layer 30 and the insulating layer 40, it is possible to effectively increase the film thickness of the overlapping portion 34, which tends to become thin while being formed. Therefore, it is possible to further equalize a pressure when the sealing layer 50 is being formed, and to further improve the closeness of contact at the interface between the sealing layer 50 after the sealing layer 50 has been formed and each layer that is a base thereof.

As illustrated in FIG. 2, the overlapping portion 34 at the end 40a of the insulating layer 40 may be composed of only the solid electrolyte layer 31 and the insulating layer 40. In this case, the layer thickness d1 corresponds to the layer thickness of the solid electrolyte layer 31 at the end 40a of the insulating layer 40.

FIG. 3 is a schematic enlarged view illustrating another example of the region of the capacitor element surrounded by the broken line in FIG. 1.

As illustrated in FIG. 3, the overlapping portion 34 at the end 40a of the insulating layer 40 may be composed of only the solid electrolyte layer 31, the carbon layer as the first conductor layer 32A, and the insulating layer 40. In this case, the layer thickness d1 corresponds to the layer thickness of a layer including the solid electrolyte layer 31 and the carbon layer (the first conductor layer 32A) at the end 40a of the insulating layer 40.

The end 40a of the insulating layer 40 may be an end of the first insulating layer 40A, or may be an end of the second insulating layer 40B as illustrated in FIGS. 2 and 3. The term “end of the insulating layer” refers to a limit point where the insulating layer vanishes as illustrated in FIGS. 2 and 3. The capacitor element 1 preferably satisfies d1≥0.2×d2, and more preferably satisfies d1≥0.5×d2.

The capacitor element 1 preferably satisfies d1≤d2. If d1>d2, when the capacitor element 1 is being sealed with the sealing layer 50, since the insulating layer 40 is lower than the negative electrode layer 30, a sealant that is the material of the sealing layer 50 easily flows into dividing portions 61 and 62 described below, and thus the closeness of contact between the insulating layer 40 and the sealing layer 50 near the dividing portions 61 and 62 may decrease. On the other hand, when d1≤d2 is satisfied, it is possible to reduce the amount of the sealant that flows into the dividing portions 61 and 62, and to suppress decrease of the closeness of contact between the insulating layer 40 and the sealing layer 50 near the dividing portions 61 and 62. Moreover, it is possible to increase the number of protrusions and recesses due to the difference between dl and d2, and a mechanical anchoring effect also can be increased.

The capacitor element 1 preferably satisfies d1≥2 μm, and more preferably satisfies d1≥5 μm. When d1≥2 μm is satisfied, even if the size of the capacitor element 1 is reduced, the overlapping portion 34 can have a minimum necessary layer thickness, and it is possible to provide a sufficient closeness of contact at the interface.

The capacitor element 1 preferably satisfies d1≤100 μm, and more preferably satisfies d1≤40 μm. When d1≤100 μm is satisfied, even if the size of the capacitor element 1 is reduced or increased, it is possible to provide a structure such that the closeness of contact between the sealing layer 50 and the thinnest part of the transition portion between the negative electrode layer 30 and the insulating layer 40 is sufficiently high.

From a similar viewpoint, the insulating layer 40 preferably satisfies 10 μm≤d2≤500 μm, and more preferably satisfies 25 μm≤d2≤200 μm.

From a similar viewpoint, the negative electrode layer 30 preferably satisfies 10 μm≤d3≤500 μm, and more preferably satisfies 25 μm≤d3≤200 μm, where d3 is the layer thickness of the negative electrode layer 30.

In a capacitor element according to the present disclosure, it is sufficient that the aforementioned features regarding the layer thicknesses d1, d2, and d3 be satisfied for at least one position in a cross section parallel to the thickness direction. However, if there are a plurality of positions in the cross section where the features can be satisfied, it is preferable that the features be satisfied at all of such positions.

In a capacitor element according to the present disclosure, the layer thickness d2 of an insulating layer means the layer thickness of the insulating layer itself that constitutes an overlapping portion where the layer thickness dl is to be measured in a cross section parallel to the thickness direction. That is, in the cross section, a portion where the layer thickness d1 is to be measured is adjacent to a portion where the layer thickness d2 is to be measured.

The insulating layer 40 is formed, for example, so as to surround a region in which the conductor layer 32 is formed or is to be formed on the periphery of the solid electrolyte layer 31 by applying an insulating material to the surface of the dielectric layer 20 overlapping the periphery of the solid electrolyte layer 31.

Examples of the insulating material of the first insulating layer 40A and the second insulating layer 40B include polyphenylsulfone, polyethersulfone, a cyanate ester resin, a fluororesin (tetrafluoroethylene, tetrafluoroethylene/perfluoroalkyl vinyl ether copolymer, or the like), a composition of a soluble polyimide siloxane and an epoxy resin, a polyimide resin, a polyamide-imide resin, and a derivative or a precursor of these.

The insulating material of the first insulating layer 40A may be the same as or different from the insulating material of the second insulating layer 40B.

The first insulating layer 40A may be made of the same resin as the sealing layer 50 described below. In contrast to the sealing layer 50, if the first insulating layer 40A includes an inorganic filler, the inorganic filler may negatively affect an effective portion of the capacitor element 1. Therefore, the first insulating layer 40A is preferably made of only a resin.

The thickness the first insulating layer 40A may be the same as the thickness of the second insulating layer 40B, may be greater than the thickness of the second insulating layer 40B, or may be less than the thickness of the second insulating layer 40B.

The thickness of the first insulating layer 40A may be the same as the thickness of the solid electrolyte layer 31, may be greater than the thickness of the solid electrolyte layer 31, or may be less than the thickness of the solid electrolyte layer 31.

The thickness of the second insulating layer 40B may be the same as the thickness of the conductor layer 32, may be greater than the thickness of the conductor layer 32, or may be less than the thickness of the conductor layer 32.

In the example illustrated in FIG. 1, the insulating layer 40 includes the first insulating layer 40A and the second insulating layer 40B. The insulating layer 40 may include another layer, in addition to the first insulating layer 40A and the second insulating layer 40B.

The capacitor element 1 preferably further includes the sealing layer 50.

The sealing layer 50 includes a resin material.

Examples of the resin material of the sealing layer 50 include an epoxy resin, a phenol resin, and a polyimide resin.

The sealing layer 50 may include, in addition to the resin material, an inorganic filler such as a silica filler or an alumina filler.

The sealing layer 50 may be composed of only one layer, or may be composed of two or more layers.

The sealing layer 50 covers the insulating layer 40 and the negative electrode layer 30.

With the capacitor element 1, since the sealing layer 50 that covers the insulating layer 40 and the negative electrode layer 30 is provided, deformation due to an external force is suppressed, and accordingly occurrence of delamination is further suppressed. Since the capacitor element includes the sealing layer that includes a resin material and that covers the insulating layer and the negative electrode layer, deformation due to an external force is suppressed, and accordingly occurrence of delamination is further suppressed.

The sealing layer 50 may be provided in such a way that a part of the positive electrode plate 10, particularly an end surface of the core portion 11, is exposed from the sealing layer 50. In this case, even though the sealing layer 50 is provided, it is possible to connect the positive electrode plate 10 to the outside of the sealing layer 50.

The sealing layer 50 is formed, for example, in a predetermined region by using a method such as a method of affixing a resin sheet so as to cover the negative electrode layer 30 or a method of applying a resin paste so as to cover the negative electrode layer 30.

The capacitor element 1 is manufactured, for example, by using the following method.

First, the positive electrode plate 10 including the porous layer 12 on each of two main surfaces of the core portion 11, that is, the positive electrode plate 10 including the porous layer 12 at each of two main surfaces thereof is prepared. Then, by anodizing the positive electrode plate 10, an oxide film to become the dielectric layer 20 is formed on a surface of the porous layer 12.

Next, by applying an insulating material to the surface of the dielectric layer 20, the first insulating layer 40A is formed so as to surround a region where the solid electrolyte layer 31 is to be formed.

Then, the solid electrolyte layer 31 is formed by repeatedly performing, on the region surrounded by the first insulating layer 40A, a process of applying a dispersion liquid of an electroconductive polymer to the surface of the dielectric layer 20 and drying the dispersion liquid a plurality of times.

Next, by applying an insulating material to the surface of the first insulating layer 40A, the second insulating layer 40B is formed so as to cover the entirety of an end portion of the solid electrolyte layer 31 in plan view from the thickness direction.

Next, by applying an electroconductive paste containing an electroconductive filler to the surface of the solid electrolyte layer 31, the first conductor layer 32A provided on the surface of the solid electrolyte layer 31 is formed. Subsequently, by applying a metal paste containing a metal filler to the surface of the first conductor layer 32A, the second conductor layer 32B provided on the surface of the first conductor layer 32A is formed. In this way, the conductor layer 32 including the first conductor layer 32A and the second conductor layer 32B is formed. Thus, a solid electrolytic capacitor sheet is obtained.

Next, by affixing a resin sheet to each of two main surfaces of the solid electrolytic capacitor sheet, the sealing layer 50 that covers the conductor layer 32 is formed, thereby manufacturing the capacitor element 1.

### Second Embodiment

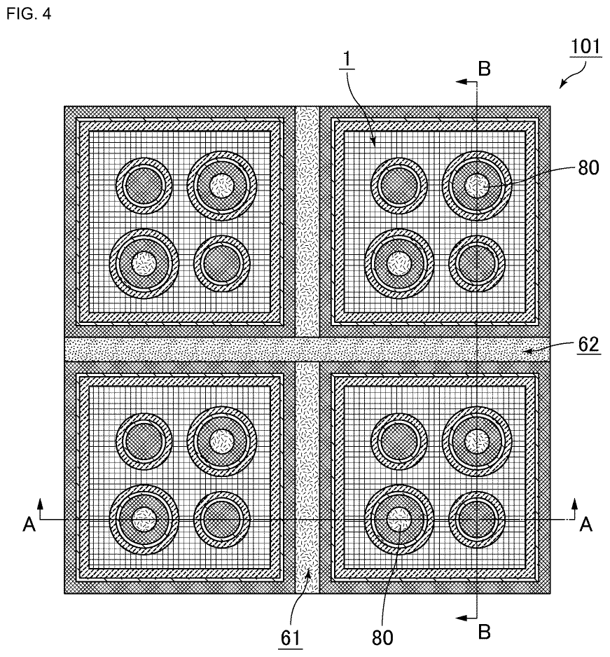

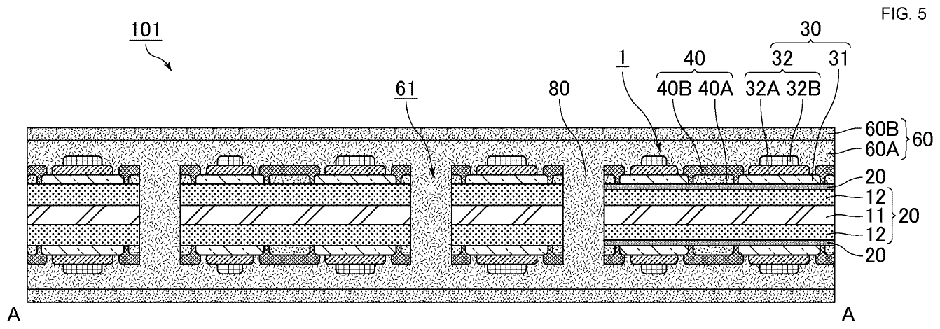

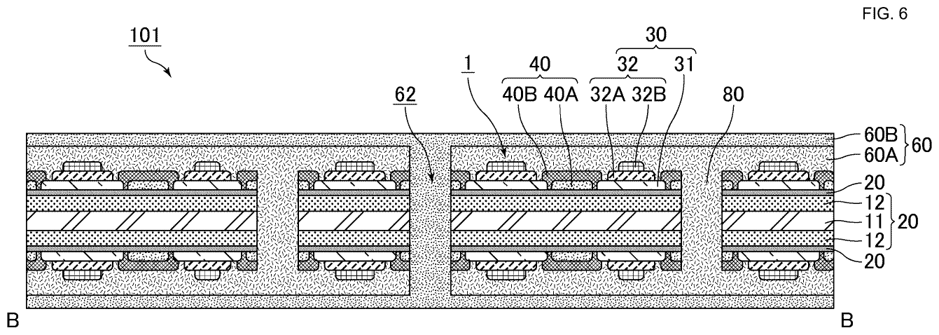

FIG. 4 is a schematic plan view illustrating an example of a capacitor array according to a second embodiment of the present disclosure. FIG. 5 is a schematic sectional view illustrating an example of a cross section of the capacitor array taken along line A-A in FIG. 4. FIG. 6 is a schematic sectional view illustrating an example of a cross section of the capacitor array taken along line B-B in FIG. 4.

A capacitor array 101 illustrated in FIGS. 4 to 6 includes a plurality of capacitor elements 1 illustrated in FIG. 1. In the example illustrated in FIGS. 4 to 6, the capacitor array 101 includes four capacitor elements 1.

With the capacitor array 101 in which the plurality of capacitor elements 1 are arranged in an array shape, while deformation due to an external force is suppressed, delamination between layers of a plurality of different materials, particularly delamination between the porous layer 12 and the solid electrolyte layer 31, does not easily occur.

By arranging the plurality of capacitor elements 1 in an array shape to form the capacitor array 101, it is possible to provide a multichannel capacitor array whose capacitance and position are optimized for market needs.

Moreover, by using the capacitor array 101 in which the plurality of capacitor elements 1 are arranged in an array shape, it is possible to efficiently mount the plurality of capacitor elements 1 on a substrate.

The plurality of capacitor elements 1 may be arranged in a planar shape, or may be arranged in a linear shape.

The plurality of capacitor elements 1 may be arranged regularly, or may be arranged irregularly.

The areas of the plurality of capacitor elements 1 when seen from the thickness direction may be the same as each other, may be different from each other, or may be partially different from each other.

The planer shapes of the plurality of capacitor elements 1 when seen from the thickness direction may be the same as each other, may be different from each other, or may be partially different from each other.

The capacitor array 101 preferably includes a sealing portion 60.

The sealing portion 60 seals the plurality of capacitor portions from both main surface sides that face each other in the thickness direction of the plurality of capacitor portions. Thus, the plurality of capacitor portions are protected by the sealing portion 60.

The sealing portion 60 is made of an insulating material. That is, the sealing portion 60 functions as an insulating portion.

The sealing portion 60 is formed by stacking a plurality of sealing layers.

The plurality of sealing layers of the sealing portion 60 includes a first sealing layer 60A and a second sealing layer 60B. In the example illustrated in FIG. 5 and other figures, the first sealing layer 60A and the second sealing layer 60B of the sealing portion 60 are stacked in the thickness direction in order from the capacitor portion side. That is, in the example illustrated in FIG. 5 and other figures, the second sealing layer 60B is adjacent to the first sealing layer 60A on a side opposite from the capacitor portion.

It is sufficient that the sealing portion 60 include at least the first sealing layer 60A and the second sealing layer 60B. The sealing portion 60 may further include at least one sealing layer between the first sealing layer 60A and the second sealing layer 60B.

The insulating material of the first sealing layer 60A may contain an insulating resin.

Examples of the insulating resin that may be contained in the insulating material of the first sealing layer 60A include an epoxy resin, a phenol resin, and a polyimide resin.

The insulating material of the first sealing layer 60A may further contain an inorganic filler.

Examples of the inorganic filler that may be contained in the insulating material of the first sealing layer 60A include a silica filler and an alumina filler.

The first sealing layer 60A is formed, for example, so as to seal the capacitor portion from both main surface sides of the capacitor portion by using a method such as a method of thermocompression bonding an insulating resin sheet or a method of applying an insulating resin paste and then thermally curing the insulating resin paste.

The insulating material of the second sealing layer 60B may contain an insulating resin.

Examples of the insulating resin that may be contained in the insulating material of the second sealing layer 60B include an epoxy resin, a phenol resin, and a polyimide resin.

The insulating materials of the first sealing layer 60A and the second sealing layer 60B preferably contain insulating resins that differ from each other.

The insulating materials of the first sealing layer 60A and the second sealing layer 60B preferably contain insulating resins that are the same as each other.

The insulating material of the second sealing layer 60B may further contain an inorganic filler.

Examples of the inorganic filler that may be contained in the insulating material of the second sealing layer 60B include a silica filler and an alumina filler.

The inorganic fillers contained in the insulating materials of the first sealing layer 60A and the second sealing layer 60B may be the same as each other or may be different from each other at least in terms of type.

The first sealing layer 60A and the second sealing layer 60B may be the same as each other or may be different from each other in the ratio of the inorganic filler content to the total amount of the insulating material.

The second sealing layer 60B is formed, for example, after the first sealing layer 60A has been formed as described above, so as to be adjacent to the first sealing layer 60A on a side opposite from the capacitor portion by using a method such as a method of thermocompression bonding an insulating resin sheet or a method of applying an insulating resin paste and then thermally curing the insulating resin paste. In this way, by forming the second sealing layer 60B by using a build-up method with respect to the first sealing layer 60A, it is not necessary to soften the first sealing layer 60A, which has been already formed, in a heat treatment for forming the second sealing layer 60B. Therefore, when the second sealing layer 60B is formed, the first sealing layer 60A and the second sealing layer 60B do not become integrated, and an interface is generated between the first sealing layer 60A and the second sealing layer 60B.

Spaces between the plurality of capacitor elements 1, which are spaces between the four capacitor elements 1 here, are also filled with the sealing portion 60.

To be more specific, dividing portions 61 that divide the plurality of capacitor elements 1 in the vertical direction of FIG. 4 are also filled with the first sealing layer 60A. A through-hole 80 for a through-hole conductor that is electrically connected to the negative electrode layer 30, which will be described below, is also filled with the first sealing layer 60A.

The dividing portion 62 that divides the plurality of capacitor elements 1 in the horizontal direction of FIG. 4 is also filled with the second sealing layer 60B.

### Third Embodiment

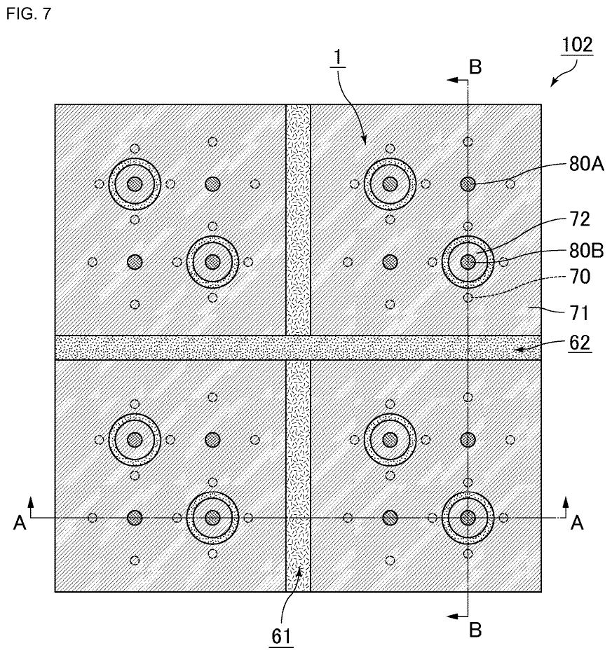

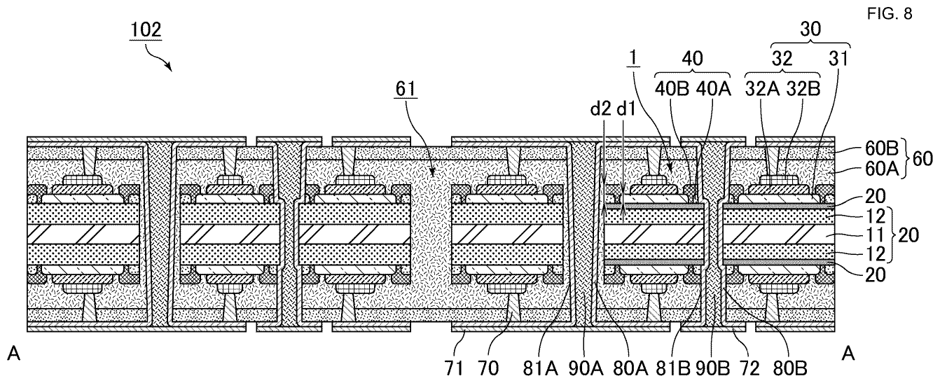

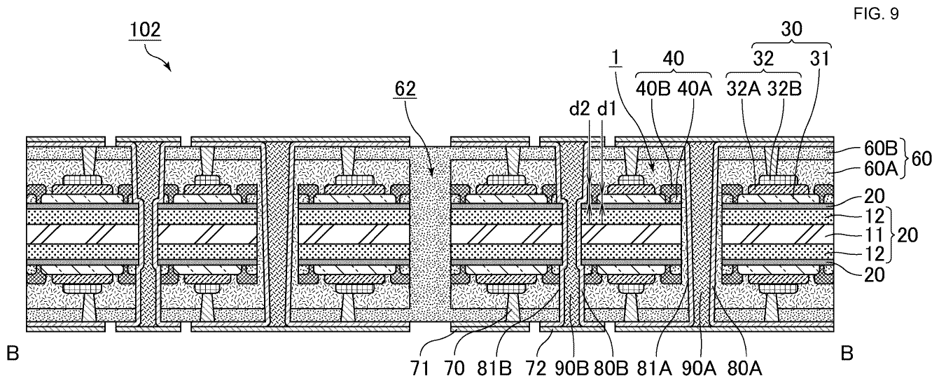

FIG. 7 is a schematic plan view illustrating an example of a capacitor array according to a third embodiment of the present disclosure. FIG. 8 is a schematic sectional view illustrating an example of a cross section of the capacitor array taken along line A-A in FIG. 7. FIG. 9 is a schematic sectional view illustrating an example of a cross section of the capacitor array taken along line B-B in FIG. 7.

A capacitor array 102 illustrated in FIGS. 7 to 9 further includes a via conductor 70, outer electrode layers 71 and 72, and through-hole conductors 80A and 80B, compared with the capacitor array 101 illustrated in FIGS. 4 to 6.

As illustrated in FIGS. 8 and 9, the layer thickness d2 is preferably the film thickness of the insulating layer 40 around the through-hole conductor 80A or 80B. The overlapping portion (having the layer thickness d1) of the negative electrode layer 30 and the insulating layer 40 may be present on the periphery of the through-hole conductors 80A and 80B or on the periphery of the dividing portions 61 and 62. When d1>0.2×d2 is satisfied on the periphery of the through-hole conductors 80A and 80B, where delamination is more likely to occur, a higher delamination-suppressing effect can be obtained.

The via conductor 70 is provided so as to extend from a surface of the sealing portion 60 to the negative electrode layer 30, to be more specific, from the surface of the sealing portion 60 to the second conductor layer 32B in the thickness direction. Thus, the negative electrode layer 30 is electrically led to the outside of the sealing portion 60 through the via conductor 70, and it is possible to electrically connect the negative electrode layer 30 to the outside of the sealing portion 60.

The via conductor 70 is connected to the outer electrode layer 71 provided on the surface of the sealing portion 60.

Examples of the material of the via conductor 70 include low-resistance metals such as silver, gold, and copper.

The via conductor 70 is formed, for example, as follows. First, a hole that extends from the surface of the sealing portion 60 to the negative electrode layer 30, here, from the surface of the sealing portion 60 to the second conductor layer 32B, in the thickness direction is formed by performing drilling, laser machining, or the like on the sealing portion 60. Then, the via conductor 70 is formed by plating the inner wall of the hole formed in the sealing layer 50 and by performing heat-treatment after filling the hole with an electroconductive paste.

The through-hole conductors 80A and 80B extend through the sealing portion 60 in the thickness direction. In the example illustrated in FIG. 8 and other figures, the through-hole conductors 80A and 80B extend through, in addition to the sealing portion 60, the positive electrode plate 10 (the core portion 11), the dielectric layer 20, and the insulating layer 40 in the thickness direction.

Since the through-hole conductors, which extend through the sealing portion 60 in the thickness direction, are provided, the sealing portion 60 has an electric function.

The through-hole conductor 80A is preferably provided on at least the inner wall of a through-hole 81A, which extends through the sealing portion 60 in the thickness direction. In the example illustrate in FIG. 8 and other figures, the through-hole conductor 80A is provided not in the entirety of the inside of the through-hole 81A but on the inner wall of the through-hole 81A.

The through-hole conductor 80A is electrically insulated from the positive electrode plate 10. As illustrated in FIGS. 8 and 9, the space between the through-hole conductor 80A and the positive electrode plate 10 is preferably filled with an insulating material such as the sealing portion 60.

The through-hole conductor 80A is connected to the outer electrode layer 71 provided on the surface of the sealing portion 60. Accordingly, the through-hole conductor 80A is electrically connected to the negative electrode layer 30 through the outer electrode layer 71 and the via conductor 70.

The through-hole conductor 80B is preferably provided on at least the inner wall of a through-hole 81B, which extends through the sealing portion 60 in the thickness direction. In the example illustrated in FIG. 8 and other figures, the through-hole conductor 80B is provided not in the entirety of the inside of the through-hole 81B but on the inner wall of the through-hole 81B.

The through-hole conductor 80B is electrically connected to the positive electrode plate 10. As illustrated in FIGS. 8 and 9, the through-hole conductor 80B is preferably electrically connected to the positive electrode plate 10 at the inner wall of the through-hole 81B. To be more specific, the through-hole conductor 80B is preferably electrically connected to an end surface of the positive electrode plate 10 that faces the inner wall of the through-hole 81B in a direction perpendicular to the thickness direction. In the example illustrated in FIG. 8 and other figures, the through-hole conductor 80B is connected to an end surface of the positive electrode plate 10, particularly an end surface of the core portion 11. Thus, the positive electrode plate 10 is electrically led to the outside through the through-hole conductor 80B. That is, the sealing portion 60 has an electrical function of electrically leading the positive electrode plate 10 to the outside. Then, the through-hole conductor 80B is connected to the outer electrode layer 72 provided on the surface of the sealing portion 60.

When seen from the thickness direction, the through-hole conductor 80B is preferably electrically connected to the positive electrode plate 10 over the entire circumference of the through-hole 81B. Thus, the connection resistance between the through-hole conductor 80B and the positive electrode plate 10 can be easily reduced, and therefore the equivalent series resistance of the capacitor element 1 can be easily reduced.

The through-hole conductor 80A is formed, for example, as follows. First, a through-hole that extends through the positive electrode plate 10 (the core portion 11), the dielectric layer 20, and the insulating layer 40 in the thickness direction is formed by performing drilling, laser machining, or the like. Next, by forming the sealing portion 60, the through-hole is filled with an insulating material. The through-hole 81A that extends through the sealing portion 60 in the thickness direction is formed by performing drilling, laser machining, or the like on the portion filled with the insulating material. At this time, by making the diameter of the through-hole 81A smaller than the diameter of the through-hole filled with the insulating material, the insulating material is made to be present between the inner wall of the through-hole that has been formed previously and the inner wall of the through-hole 81A in the in-plane direction. Then, the through-hole conductor 80A is formed by metalizing the inner wall of the through-hole 81A with a low-resistance metal such as copper, gold, or silver. When the through-hole conductor 80A is to be formed, for example, it is easy to perform processing by metalizing the inner wall of the through-hole 81A by electroless copper plating, electrolytic copper plating, or the like. A method of forming the through-hole conductor 80A may be, instead of the method of metallizing the inner wall of the through-hole 81A, a method of filling the through-hole 81A with a metal, a composite material of a metal and a resin, or the like.

The through-hole conductor 80B is formed, for example, as follows. First, the through-hole 81B that extends through the sealing portion 60, the positive electrode plate 10 (the core portion 11), the dielectric layer 20, and the insulating layer 40 in the thickness direction is formed by performing drilling, laser machining, or the like. Then, the through-hole conductor 80B is formed by metalizing the inner wall of the through-hole 81B with a low-resistance metal such as copper, gold, or silver. When the through-hole conductor 80B is to be formed, for example, it is easy to perform processing by metalizing the inner wall of the through-hole 81B by electroless copper plating, electrolytic copper plating, or the like. A method of forming the through-hole conductor 80B may be, instead of the method of metallizing the inner wall of the through-hole 81B, a method of filling the through-hole 81B with a metal, a composite material of a metal and a resin, or the like.

The outer electrode layer 71 is electrically connected to the negative electrode layer 30. In the example illustrated in FIG. 8 and other figures, the outer electrode layer 71 is provided on a surface of the through-hole conductor 80A, and functions as a connection terminal of the capacitor array 102 (the capacitor element 1). In the example illustrated in FIG. 8 and other figures, the outer electrode layer 71 is electrically connected to the negative electrode layer 30 through the via conductor 70, and functions as a connection terminal for the negative electrode layer 30.

Examples of the material of the outer electrode layer 71 include a metal material containing a low-resistance metal such as silver, gold, or copper. In this case, the outer electrode layer 71 is formed, for example, by plating the surface of the through-hole conductor 80A.

In order to increase the closeness of contact between the outer electrode layer 71 and another member, here, the closeness of contact between the outer electrode layer 71 and the through-hole conductor 80A, a mixed material of a resin and at least one electroconductive filler selected from the group consisting of a silver filler, a copper filler, a nickel filler, and a carbon filler may be used as the material of the outer electrode layer 71.

The outer electrode layer 72 is electrically connected to the positive electrode plate 10. In the example illustrated in FIG. 8 and other figures, the outer electrode layer 72 is provided on a surface of the through-hole conductor 80B, and functions as a connection terminal of the capacitor array 101 (the capacitor element 1). In the example illustrated in FIG. 8 and other figures, the outer electrode layer 72 is electrically connected to the positive electrode plate 10 through the through-hole conductor 80B, and functions as a connection terminal for the positive electrode plate 10.

Examples of the material of the outer electrode layer 72 include a metal material containing a low-resistance metal such as silver, gold, or copper. In this case, the outer electrode layer 72 is formed, for example, by plating the surface of the through-hole conductor 80B.

In order to increase the closeness of contact between the outer electrode layer 72 and another member, here, the closeness of contact between the outer electrode layer 72 and the through-hole conductor 80B, a mixed material of a resin and at least one electroconductive filler selected from the group consisting of a silver filler, a copper filler, a nickel filler, and a carbon filler may be used as the material of the outer electrode layer 72.

The materials of the outer electrode layer 71 and the outer electrode layer 72 may be the same as each other or may be different from each other at least in terms of type.

In the example illustrated in FIGS. 7 to 9, in each of the plurality of capacitor elements 1, the outer electrode layer 71, which is electrically connected to the negative electrode layer 30, and the outer electrode layer 72, which is electrically connected to the positive electrode plate 10, are provided. However, at least one of the outer electrode layer 71 and the outer electrode layer 72 may be provided common to the plurality of capacitor elements 1.

In the example illustrated in FIGS. 7 to 9, the outer electrode layer 71 and the outer electrode layer 72 are provided on each of two main surface sides of the sealing portion 60. However, the outer electrode layer 71 and the outer electrode layer 72 may be provided only on one main surface side of the sealing portion 60.

The capacitor array 102 preferably further includes a resin-filled portion 90A that is formed by filling the through-hole 81A with a resin material. In the example illustrated in FIG. 8 and other figures, the resin-filled portion 90A is provided in a space on the inner wall of the through-hole 81A surrounded by the through-hole conductor 80A. When the space in the through-hole 81A is filled by providing the resin-filled portion 90A, occurrence of delamination of the through-hole conductor 80A is suppressed.

The capacitor array 102 need not include the resin-filled portion 90A. In this case, the through-hole conductor 80A is preferably provided not only on the inner wall of the through-hole 81A but also in the entirety of the inside of the through-hole 81A.

The capacitor array 102 preferably further includes a resin-filled portion 90B that is formed by filling the through-hole 81B with a resin material. In the example illustrated in FIG. 8 and other figures, the resin-filled portion 90B is provided in a space on the inner wall of the through-hole 81B surrounded by the through-hole conductor 80B. When the space in the through-hole 81B is filled by providing the resin-filled portion 90B, occurrence of delamination of the through-hole conductor 80B is suppressed.

The capacitor array 102 need not include the resin-filled portion 90B. In this case, the through-hole conductor 80B is preferably provided not only on the inner wall of the through-hole 81B but also in the entirety of the inside of the through-hole 81B.

A capacitor element according to the present disclosure is used, for example, in a composite electronic component. The composite electronic component includes, for example, a capacitor element according to the present disclosure, an outer electrode that is provided on an outer side portion of a capacitor element according to the present disclosure and that is electrically connected to each of the positive electrode plate and the negative electrode layer, and an electronic component that is electrically connected to the outer electrode.

In the composite electronic component, the electronic component that is electrically connected to the outer electrode may be a passive element, may be an active element, may be both of a passive element and an active element, or may be a composite of a passive element and an active element.

Examples of the passive element include an inductor.

Examples of the active element include a memory, a GPU (Graphical Processing Unit), a CPU (Central Processing Unit), an MPU (Micro Processing Unit), and a PMIC (Power Management IC).

When a capacitor element according to the present disclosure is used in a composite electronic component, the capacitor element according to the present disclosure is treated, for example, as a substrate for mounting electronic components as described above. Therefore, by forming a capacitor element according to the present disclosure to be sheet-shaped as a whole and further forming an electronic component to be mounted on the capacitor element according to the present disclosure to be sheet-shaped, it is possible to electrically connect the capacitor element according to the present disclosure and the electronic component in the thickness direction via through-hole conductors that extend through the electronic component in the thickness direction. As a result, it is possible to configure a passive element and an active element as electronic components like an integrated module.

For example, it is possible to form a switching regulator by electrically connecting a capacitor element according to the present disclosure between a voltage regulator including a semiconductor active element and a load to which a converted direct electric voltage is to be supplied.

In a composite electronic component, after forming a circuit layer on one main surface of a capacitor element sheet in which a plurality of capacitor elements each according to the present disclosure are laid out, the circuit layer may be electrically connected to a passive element or an active element as an electronic component.

A capacitor element according to the present disclosure may be disposed in a cavity portion that is provided in a substrate beforehand, the cavity may be filled with a resin, and then a circuit layer may be formed on the resin. A passive element or an active element as another electronic component may be mounted in another cavity portion of the substrate.

Alternatively, a capacitor element according to the present disclosure may be mounted on a smooth and flat carrier such as a wafer or a glass plate, a circuit layer may be formed after forming an outer layer portion from a resin, and then the circuit layer may be electrically connected to a passive element or an active element as an electronic component.

The following contents are disclosed in the present description.
<1> A capacitor element comprising: a positive electrode plate including a porous layer on at least one main surface thereof; a dielectric layer on a surface of the porous layer; a negative electrode layer on a surface of the dielectric layer; and an insulating layer on the surface of the dielectric layer and arranged so as to partially overlap the negative electrode layer, wherein d1≥0.2×d2, where d1 is a layer thickness of an overlapping portion of the negative electrode layer and the insulating layer at an end of the insulating layer overlapping the negative electrode layer, and d2 is a layer thickness of the insulating layer.
<2> The capacitor element according to <1>, wherein d1≤d2.
<3> The capacitor element according to <1> or <2>, wherein d1≥2 μm.
<4> capacitor element according to <3>, wherein d1≤100 μm.
<5> The capacitor element according to any one of <1> to <4>, wherein 10 μm≤d2≤500 μm.
<6> The capacitor element according to any one of <1> to <5>, wherein 10 μm≤d3≤500 μm, where d3 is a layer thickness of the negative electrode layer.
<7> The capacitor element according to any one of <1> to <6>, wherein the negative electrode layer includes a solid electrolyte layer on the surface of the dielectric layer and a conductor layer on a surface of the solid electrolyte layer, and wherein the overlapping portion includes the insulating layer and at least one of the solid electrolyte layer and the conductor layer.
<8> The capacitor element according to <7>, wherein the overlapping portion includes only the solid electrolyte layer and the insulating layer.
<9> The capacitor element according to <7>, wherein the overlapping portion includes only the solid electrolyte layer, the conductor layer, and the insulating layer.
<10> The capacitor element according to any one of <1> to <9>, further comprising a sealing layer covering the insulating layer and the negative electrode layer.

### REFERENCE SIGNS LIST

1 capacitor element
10 positive electrode plate
11 core portion
12 porous layer
20 dielectric layer
30 negative electrode layer
31 solid electrolyte layer
32 conductor layer
32A first conductor layer
32B second conductor layer
34 overlapping portion of negative electrode layer and insulating layer
40 insulating layer
40a end of insulating layer overlapping negative electrode layer
40A first insulating layer
40B second insulating layer
50 sealing layer
60 sealing portion
60A first sealing layer
60B second sealing layer
61, 62 dividing portion
70 via conductor
71, 72 outer electrode layer
80A, 80B through-hole conductor
81A, 81B through-hole
90A, 90B resin-filled portion
101, 102 capacitor array

1. A capacitor element comprising:
a positive electrode plate including a porous layer on at least one main surface thereof;
a dielectric layer on a surface of the porous layer;
a negative electrode layer on a surface of the dielectric layer; and
an insulating layer on the surface of the dielectric layer and arranged so as to partially overlap the negative electrode layer,
wherein d1≥0.2×d2,
where d1 is a layer thickness of an overlapping portion of the negative electrode layer and the insulating layer at an end of the insulating layer overlapping the negative electrode layer, and d2 is a layer thickness of the insulating layer.

2. The capacitor element according to claim 1, wherein d1≥0.5×d2.

3. The capacitor element according to claim 1, wherein d1≤d2.

4. The capacitor element according to claim 3, wherein d1≥2 μm.

5. The capacitor element according to claim 4, wherein d1≤100 μm.

6. The capacitor element according to claim 1, wherein d1≥2 μm.

7. The capacitor element according to claim 6, wherein d1≤100 μm.

8. The capacitor element according to claim 1, wherein d1≥5 μm.

9. The capacitor element according to claim 8, wherein d1≥40 μm.

10. The capacitor element according to claim 1, wherein 10 μm≤d2≤500 μm.

11. The capacitor element according to claim 1, wherein 10 μm≤d2≤200 μm.

12. The capacitor element according to claim 1,
wherein 10 μm≤d3≤500 μm,
where d3 is a layer thickness of the negative electrode layer.

13. The capacitor element according to claim 12, wherein 25 μm≤d2≤200 μm.

14. The capacitor element according to claim 1,
wherein the negative electrode layer includes a solid electrolyte layer on the surface of the dielectric layer and a conductor layer on a surface of the solid electrolyte layer, and
wherein the overlapping portion includes the insulating layer and at least one of the solid electrolyte layer and the conductor layer.

15. The capacitor element according to claim 14, wherein the overlapping portion includes only the solid electrolyte layer and the insulating layer.

16. The capacitor element according to claim 14, wherein the overlapping portion includes only the solid electrolyte layer, the conductor layer, and the insulating layer.

17. The capacitor element according to claim 14, wherein the conductor layer is a carbon layer.

18. The capacitor element according to claim 1, further comprising a sealing layer covering the insulating layer and the negative electrode layer.
